(19) United States
(12) Patent Application Publication
(10) Pub. No.: US 2007/0157149 A1
(43) Pub. Date: Jul. 5, 2007

(54) Design configuration method for an automation system

(75) Inventors: Holger Grzonka, Alpharetta, GA (US); Uwe Hafner, Kurnach (DE); Christof Meier, Heroldsbach (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 10/597,961

(22) PCT Filed: Jan. 4, 2005
(86) PCT No.: PCT/EP05/50016

§ 371 Date: Aug. 14, 2006

(30) Foreign Application Priority Data
Feb. 13, 2004 (DE) 10 2004 007 229.9

(51) Int. Cl. G06F 17/50

(52) U.S. Cl. 716/16; 716/18

(57) ABSTRACT

The invention relates to a projection method for an automation system, in addition to a device which is used to project an automation system. In order to simplify the projection of an automation system, projection data for at least one component (10, 10 12,14) of the automation system is combined in an information object (30,40). The projection data comprises at least HMI data (20,22,24,32,42) and control data (16, 18,34,44) for the components (10,12,14).

The invention relates to a design configuration method for an automation system and a device for performing design configuration of an automation system.

When design configuration is performed on an automation system, hardware configurations are designed using an engineering system. To do this, for example the systems SIMATIC or SIMOTION from SIEMENS AG are used. This design configuration data comprises object models of the automation equipment of the automation system and is stored in the memory of the automation system. It is used for performing open-loop and/or closed-loop control of the piece of technical equipment by means of what is referred to as the run time system, which is implemented by means of a software-controlled microcontroller.

In addition to the design configuration of the hardware configurations of the automation system, design of the human-machine interface (HMI) between the automation system and the user is configured. This involves producing all the display images, operator control sequences, help images, fault messages etc. for the entire automation system.

In particular in complex pieces of technical equipment, the machines which are to be controlled by the automation system are frequently composed of a multiplicity of modules which are manufactured in the manner of a kit system from one manufacturer or from different manufacturers, and are combined to form one overall system. If, for example, the technical parameters of the machine module are modified by the manufacturer or if changes in the composition of the machines or the machine modules are necessary owing to modified requirements of the overall system, complex and costly adaptation of the HMI system is always necessary.

The object of the present invention is to simplify the design configuration of an automation system. This object is achieved by means of a method as claimed in claim 1.

According to this there is provision for design configuration data to be combined on a component basis in information objects. The design configuration data comprises here both HMI data of the component and control data of the component so that at the end of the design configuration phase of each component of the automation system a complete component-specific data record can be assigned, which record comprises both the logic representation of the component from the technical control point of view and at the same time all the HMI elements. In other words, according to the invention the HMI design configuration and the control design configuration are linked to one another at the component level. As a result, a view of the individual components in terms of machinery or equipment is produced in which the focus is on the functionality of individual components. In contrast to the traditional way of viewing them, which is based on the automation structure in its entirety, this results in a component-related view which corresponds much more to that of a mechanical engineer.

It is advantageous here that modifications to a component do not have any effects whatsoever on the HMI design configuration of the entire machine. Individual components of the automation system can thus be omitted, replaced or modified without the need to change the HMI design configuration of other components. HMI changes of a component do not have any effect on other components of the automation system.

The present invention does not only permit very variable design configuration of an automation system but also allows individual components to be put into service separately by means of the HMI. In addition, modifications, in particular HMI modifications, can be carried out in an extremely variable way. The same applies to the running time of the system when retrofits are made and modifications or maintenance is carried out. As a result the costs for design configuration, putting into service and maintenance are reduced.

In addition to a design configuration method for an automation system which is distinguished by such a combination of the design configuration data, the invention also relates to a corresponding device for performing design configuration of an automation system. Furthermore, a computer program with program code means and a computer program product with program code means which are stored on a machine-readable carrier are provided according to the invention, and are designed to carry out all the steps as per the method according to the invention when the program is carried out on a computer.

The invention can be implemented either in software or hardware, for example using a specific electrical circuit. In addition, the invention can be implemented by means of a computer-readable memory medium on which the computer program which carries out the invention is stored with program code means. The invention can also be implemented by means of a computer program product which has a memory medium on which the computer program which carries out the invention is stored with program code means.

The invention also relates to the product which is produced by the design configuration method according to the invention, preferably in the form of data records which can be processed by the run time system and which comprise the information objects according to the invention, or in the form of a computer program which can be run on a run time system. The invention also relates to a run time system for performing open-loop or closed-loop control of a piece of technical equipment, which run time system is preferably embodied in the form of a software-controlled microcontroller and is designed to use a product produced by the design configuration method according to the invention. Finally, the invention also relates to a piece of technical equipment which is designed in such a way that its closed-loop or open-loop control is performed by a run time system according to the invention.

Advantageous developments of this invention emerge from the subclaims. These and all further developments described below relate both to the method according to the invention and to a corresponding device according to the invention for performing design configuration of an automation system.

The component of the automation system for which the design configuration data is combined can either be a machine or an individual module of such a machine, that is to say a subcomponent which is independent in terms of machinery or equipment. Such machine modules are also referred to below as assemblies.

If the component is an assembly, the information object does not only comprise the assembly-specific HMI information but also the logic representation of the assembly from the point of view of control equipment. In other words, the information object combines all the assembly-related data and logic points of view. It thus serves as a container and is also referred to below as assembly container.

If the component is a machine, the information object does not only comprise the machine-specific HMI information but also the logic representation of the relationships between the assemblies of the machine from the point of view of control equipment as well as the logic representation of the machine functionality which covers all the assemblies In other words, the information object combines all the machine-related data and logic points of view. It also serves as a container and is likewise referred to below as machine container.

In a further embodiment of the invention, in addition to the HMI data and the control data of the component, further design configuration data is contained in the information object. This data is preferably the design configuration data of the drives of the piece of technical equipment which are used in the control process.

Each information object is advantageously capable of being processed individually, i.e. independently. The design configuration of the automation system for the various components can thus be carried out in parallel one next to the other. When modifications are made to individual control parameters or HMI parameters it is no longer necessary to intervene in the entire system. Since, for example, amendments can be made to the HMI design configuration at the assembly level without any further adaptations being necessary to the HMI design configuration of the machine or to the control design configuration in further subsequent steps, an extremely simple and user-friendly design configuration is possible.

Assembly containers and machine containers are preferably embodied in such a way that they can be integrated to form one overall design configuration, which is also referred to as a machine design configuration. This overall design configuration forms the entire hardware of the automation design configuration. It forms the logic totality of all the information and thus describes the view of the overall machine in terms of control equipment. The overall design configuration contains both the assembly containers which describe the submodules of the machine and the machine container which covers all the assemblies, and it connects them. A variety of overall design configurations can in turn be combined to form superordinate units, for example production lines or the like.

The design configuration is simplified further if both the logic structure of the automation system and that of the individual components are mapped in a uniform form of display. It is particularly advantageous in this context if the user interface of the design configuration system makes available a corresponding display possibility, for example in a type of tree structure. This ensures an overall identical view of the assembly containers or machine containers both when there is local operator control and when there is centralized operator control of the machine.

The invention will be explained in more detail below with reference to an exemplary embodiment which is described in more detail using the FIGS., of which:

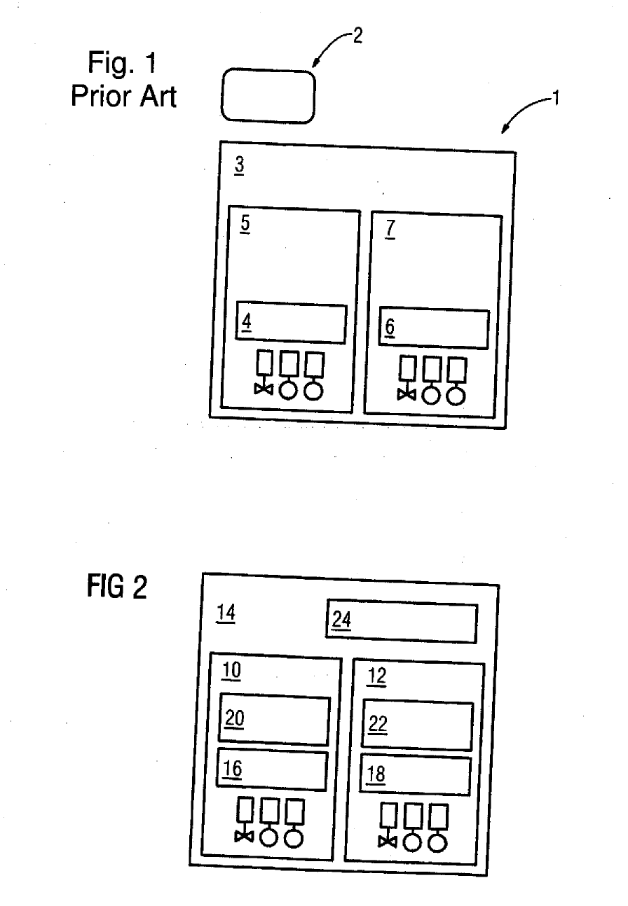

FIG. 1 is a schematic illustration of an HMI design configuration according to the prior art,

FIG. 2 is a schematic illustration of an HMI design configuration according to the invention,

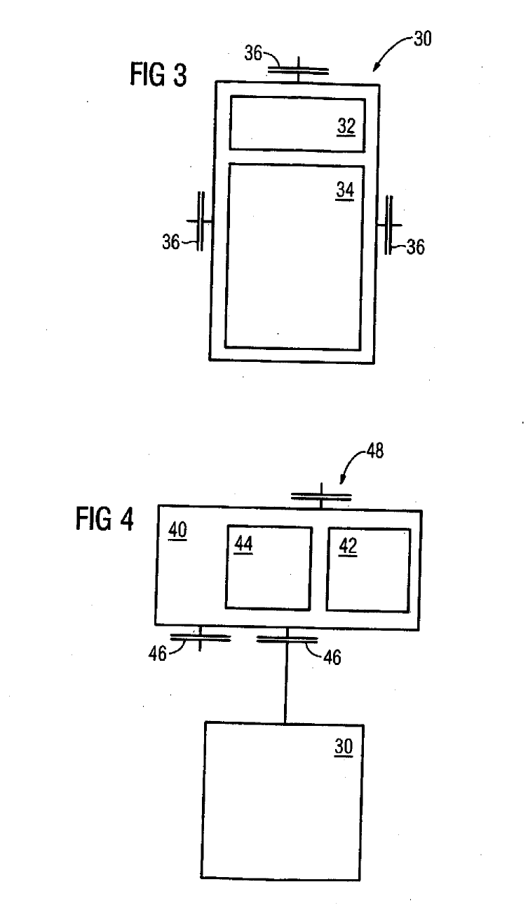

FIG. 3 is a schematic illustration of an assembly container,

FIG. 4 is a schematic illustration of a machine container,

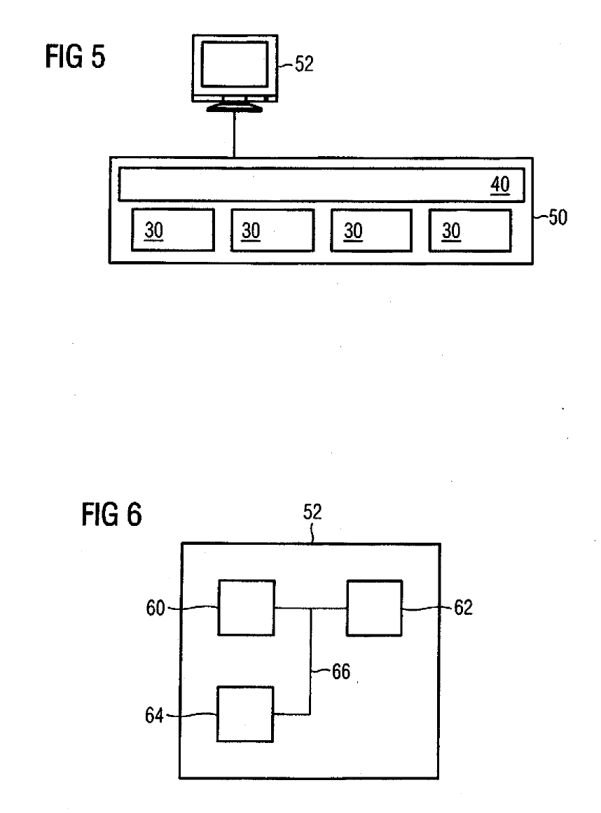

FIG. 5 is a schematic illustration of a design configuration system, and

FIG. 6 is a further schematic illustration of a design configuration system.

FIG. 1 is a schematic illustration of an HMI design configuration according to the prior art. The design configuration comprises both a control component 1 and an HMI component 2, which is separate therefrom and independent thereof, for a machine 3. While the control component 1 includes the control data 4 for the first machine assembly 5 and the control data 6 for the second machine assembly 7, the HMI component 2 contains all the operator control elements both for the machine 3 and for the assemblies 5, 7.

FIG. 2 is a schematic illustration of an HMI design configuration according to the invention. According to the FIG., the HMI design configuration and control configuration are linked to one another both at the machine level and at the assembly level. Each individual assembly 10, 12 of the overall machine 14 is assigned both the control elements 16, 18 and their corresponding HMI elements 20, 22. The overall machine 14 also has its own HMI element 24.

FIG. 3 is a schematic illustration of an information object in the form of an assembly container 30. The assembly container 30 comprises all the design configuration data which is relevant for automation. The assembly container 30 thus comprises, on the one hand, the assembly-related, local HMI elements 32, in particular operator control sequences, operator control texts, help texts and report texts, operator control structures such as, for example, menu trees, alarms, fault messages, diagnostic aids, assembly graphics such as, for example, exploded images of the equipment components and automation technology components, soft key operator controls and other settings as well as all the further, so-called HMI images.

The assembly container 30 furthermore comprises design configuration data in the form of assembly-related control elements 34, in particular data relating to the assembly hardware such as, for example, the type of CPU, order designations, version numbers etc., data relating to controllers, if provided locally in the assembly, various software items such as firmware and kernel software of the control system, if provided locally in the assembly, assembly-specific technology process software, details about the assembly axles, controllers etc. as well as assembly user software programs in source code and/or object code and assembly user software data.

Furthermore, the assembly container 30 contains further assembly-related design configuration data items, in particular a description of the entire mechanics of the assembly, including the engines, gearboxes etc., data on the drives, the signal transmitters, the actuators, the entire periphery and possibly present sensors for, for example, image processing, data on the mechanical interfaces, feed lines, discharge lines etc., a description of the assembly interfaces 36 for communication with other assemblies and the entire machine 14, in particular all the logic and electrical information as well as local communication drivers etc.

Each assembly 10, 12 of the machine 14 can in turn be constructed from sub-assemblies. For this reason, the assembly containers 30 are configured in such a way that they can also be constructed from subcontainers. In this context, inheritance of properties between the containers 30 is preferably possible.

FIG. 4 is a schematic illustration of an information object in the form of a machine container 40. The machine container 40 comprises the machine-related, global HMI elements 42, in particular all the machine images, machine operator control sequences, machine aids, machine diagnostics etc.

Furthermore, the machine container 40 comprises the control elements 44 of the machine 14, in particular all the necessary information about the hardware, the global controllers, various machine-related software items, the kernel software of the machine control system, the technology process software for the machine regulators etc., data about the machine axles, that is to say those axles whose relationships are distributed over a plurality of assemblies (such as for example control axles, synchronizing shafts, line shafts which extend through), the machine user software and data as well as information about machine functions which apply to all assemblies.

Furthermore, the machine container 40 comprises further machine-related data, in particular about external machine interfaces, in particular interfaces 46 with the individual assembly containers and interfaces 48 with other machines and information about the central machine communication, in particular the global drivers.

Finally, FIG. 5 is a schematic representation of an overall design configuration 50. The entire design configuration 50 is processed using an engineering system 52 by combining machines 14 and assemblies 10, 12. The overall design configuration 50 accordingly comprises a plurality of individual assembly containers 30 which correspond to the submodules of the machine 14, as well as a machine container 40 which applies to all the assemblies and contains the machine information which applies to all the assemblies.

Assembly containers 30 and machine containers 40 are preferably embodied in such a way that they can be archived, for example similarly to a library. Assembly containers 30 and machine containers 40 can preferably be versioned separately. In this context, in particular the assembly containers 30 can be versioned both independently of one another and independently of the overall machine. Machine containers 30 and assembly containers 40 can preferably be protected, for example by means of a read protection or write protection. The containers 30, 40 can preferably be independently produced, edited and configured. Each container 30, 40 can preferably be parameterized and configured at its interfaces 36, 46, 48 without a need to change the source codes. All this preferably applies correspondingly to the overall design configuration 50.

Machine containers 40 and assembly containers 30 can preferably be processed completely independently of one another. Here, the HMI elements 20, 22, 24 are preferably available in an identical logical structure for the entire automation system. This applies to the individual assembly HMIs and to the entire HMI of the machine 14.

The design configuration data of each component 10, 12, 14 is preferably written into a component-specific, nonvolatile memory before the component 10, 12, 14 is delivered. However, it is also possible to include the design configuration data on a memory card or some other carrier medium, for example a CD-ROM, the component 10, 12, 14.

FIG. 6 shows a device according to the invention for carrying out the design configuration method. In the exemplary embodiment, this device is embodied as an engineering system 52 in the form of a personal computer. The engineering system 52 comprises a control component 60 for combining design configuration data in an assembly container 30 or machine container 40, an HMI component 62 for inputting and outputting information, a memory component 64 for storing assembly containers 30 or machine containers 40 and a communications system 66 for transmitting data between these components 62, 64, 66. The control component 62 preferably comprises here a microprocessor which is designed to carry out the design configuration method according to the invention. The HMI component 64 preferably comprises a combined input/output device, for example in the form of a touchscreen. However, it can also comprise conventional input/output elements such as, for example, a computer screen as well as a keyboard and mouse. The memory component 66 is preferably a nonvolatile magnetic memory, for example a hard disk memory. The communication system 68, preferably in the form of a bus system, connects the components to one another and permits data to be exchanged by using a communication protocol.

1. A design configuration method for an automation system, characterized by the combination of design configuration data for at least one component (10, 12, 14) of the automation system in an information object (30, 40), the design configuration data comprising at least HMI data (20, 22, 24, 32, 42) and control data (16, 18, 34, 44) of the component (10, 12, 14).

2. The design configuration method as claimed in claim 1, characterized in that the component is a machine (14) or a machine module (10, 12).

3. The design configuration method as claimed in claim 1 or 2, characterized in that the information object (30, 40) can be processed individually.

4. The design configuration method as claimed in one of claims 1 to 3, characterized by the combination of information objects (30, 40) to form one entire design configuration (50).

5. The design configuration method as claimed in one of claims 1 to 4, characterized by the logic structure of the automation system and the logic structure of the components (10, 12, 14) of the automation system being displayed in the same manner of display.

6. A device (52) for performing design configuration of an automation system, characterized by an information object (30, 40) in which design configuration data for at least one component (10, 12, 14) of the automation system is combined, the design configuration data comprising at least HMI data (20, 22, 24, 32, 42) and control data (16, 18, 34, 44) of the component (10, 12, 14).

7. The device (52) for performing design configuration of an automation system as claimed in claim 1, having a control component (60) for combining design configuration data for at least one component (10, 12, 14) of the automation system in an information object (30, 40), the design configuration data comprising at least HMI data (20, 22, 24, 32, 42) and control data (16, 18, 34, 44) of the component (10, 12, 14), having an HMI component (62) for inputting and outputting information, having a memory component (64) for storing information objects (30, 40) and having a communication system (66) for transmitting data between the components (60, 62, 64).

8. A computer program having program code means for carrying out all the steps as claimed in claim 1 when the program is run on a computer (52).

9. The computer program with program code means as claimed in claim 8, which are stored on a computer-readable data carrier.

10. A computer program product having program code means which are stored on a machine-readable carrier, in order to carry out all the steps as claimed in claim 1 when the program is run on a computer (52).
